(19) United States
(12) Patent Application Publication
(10) Pub. No.: US 2008/0225124 A1
(43) Pub. Date: Sep. 18, 2008

(54) Demo Mode For Digital Cameras And Other Electronic Devices

(76) Inventors: Charles E. Schinner, Windsor, CO (US); Amol Subhash Pandit, Greeley, CO (US); Lisa M. Geer, Fort Collins, CO (US); Karen E. Williams, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/686,805

(22) Filed: Mar. 15, 2007

(51) Int. Cl. H04N 5/225

(52) U.S. Cl. 348/207.99; 348/E05.024

(57) ABSTRACT

Digital cameras, systems, and methods for implementing a demo mode are disclosed. An exemplary method of demonstrating a digital camera to a user may comprise activating a demo mode that displays demonstrative camera display images. The method may also comprise suspending the demo mode so that a user can try various camera settings. The method may also comprise, after a time-out, resetting the camera settings to a default state.

### BACKGROUND

Digital cameras are widely commercially available, ranging both in price and in operation from sophisticated single lens reflex (SLR) cameras used by professional photographers to inexpensive “point-and-shoot” cameras that nearly anyone can use with relative ease. Accordingly, there are typically many makes and models on display for potential buyers to choose from when purchasing a camera.

When televisions are put on display at stores, the televisions are often provided with rich video and sound demonstrations so that potential buyers can experience the capabilities of the television right there at the store. Digital cameras, however, are typically just plugged into a power source or provided with batteries so that potential buyers can try out. Little, if anything, is available to demonstrate the camera capabilities to potential buyers.

After trying a camera on display at the store (e.g., changing some of the camera settings and/or taking sample pictures), most potential buyers just return the camera in its current state to the display shelf. Accordingly, the camera may not be returned to its “best” settings to demonstrate its features, and the camera may have sample pictures still stored in memory when the next potential buyer wants to try the camera. Eventually, the camera memory fills up with sample pictures and the next potential buyer is unable to take any more sample pictures without first deleting the sample pictures already stored in memory by previous users. In addition, finding the camera's “best” settings for trying the camera can be time-consuming and frustrating, particularly for a potential buyer who may not be familiar with the particular camera and how it works. Potential buyers may thus seek out a different camera to try and possibly buy instead.

### BRIEF DESCRIPTION OF THE DRAWINGS

FIG. 1 is a perspective view of an exemplary digital camera and an exemplary demo dongle for implementing a demo mode on the digital camera.

FIG. 2 is a schematic diagram showing an exemplary circuit which may be provided for the demo dongle shown in FIG. 1 to implement a demo mode for digital cameras.

FIG. 3 is a block diagram of exemplary operational components which may be provided for the camera shown in FIG. 1 to implement a demo mode.

FIG. 4 is a flowchart illustrating exemplary operations to implement a demo mode for digital cameras.

### DETAILED DESCRIPTION

Systems and methods are disclosed for implementing a demo mode on digital cameras. In exemplary embodiments, the demo mode may be activated automatically (without user input) when a demo dongle is connected to the digital camera. In other embodiments, the demo mode may also be manually activated via a menu option or through button presses on the digital camera itself. The demo mode may display demonstrative camera display images (e.g., marketing, advertising, user instructions, camera features, etc.) on the camera's display. The demo mode may also include an easy-to-use interface displayed on the digital camera and navigated by the user setting up the camera for display with conventional camera controls (e.g., arrow buttons and zoom levers already provided on the camera). The user needs little, if any, knowledge about the camera to set up the camera for display.

When a potential customer wants to try various features of the camera, the potential customer simply uses the camera which suspends the demo mode and enters camera mode. Accordingly, the user is able to try various camera settings and take sample pictures. After the user is done, camera settings may be reset, the sample pictures deleted, and the camera automatically re-enters demo mode so that the digital camera is ready for the next user. Accordingly, the next potential buyer to try the camera does not need to manually reset the camera settings and/or delete pictures to free up memory before being able to try the camera functions.

Although the systems and methods are described herein as they may be implemented on a digital camera, it is noted that the systems and methods may also be implemented on any of a wide variety of other imaging devices and even other types of electronic devices (e.g., mobile phones, media players, etc.).

### Exemplary Systems

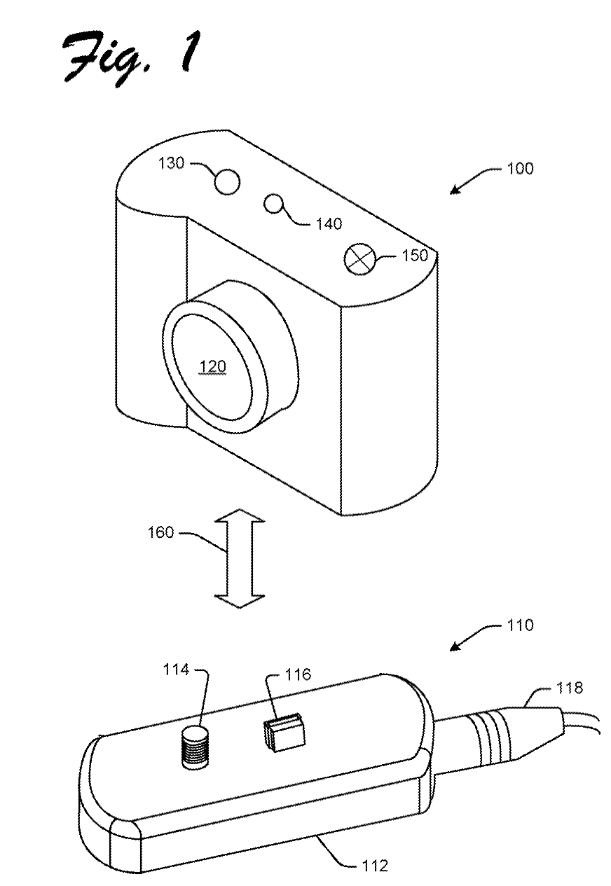

FIG. 1 is a perspective view of an exemplary digital camera 100 and an exemplary demo dongle 110 for implementing a demo mode on the digital camera 100. Digital camera 100 may be any suitable still or video camera. The exemplary digital camera 100 shown in FIG. 1 may include a lens 120, power button 130, and image capture button 140. A camera settings knob 150 may also be provided for selecting one or more camera settings on the digital camera 100.

Other camera controls, not shown, may also be provided for digital camera 100. For example, an LCD or other display typically provided on the back side of the digital camera 100 (and therefore not visible in FIG. 1) may implement a graphical user interface that the user may operate to change various camera settings. Other camera controls may include zoom buttons, rocker switches, etc. These and still other camera controls are well known to those having ordinary skill in the camera arts and therefore, for purposes of brevity, these are not shown in the drawings or discussed further herein.

In an exemplary embodiment, the demo dongle 110 may include a base member 112 with fastener 114, port 116, and power connection 118. In use, fastener 114 physically connects the base member 112 to the digital camera 100 (e.g., to the tripod mount underneath the camera and therefore not visible in FIG. 1), as illustrated by arrows 160, so that the data and power connection between port 116 and a dock on the digital camera 100 (also underneath the camera and therefore not visible in FIG. 1) remains intact even when users pick up and operate the digital camera 100. It is noted that the tripod mount and dock are common features on most digital cameras and therefore further explanation or illustration is not needed herein.

In FIG. 1, fastener 114 is shown as a threaded fastener, port 116 is shown as a Universal Serial Bus (USB) connector, and power connection 118 is shown as an electrical power cord. It is noted, however, that substitutions may be made. For example, the demo dongle 110 may be battery controlled, a FIREWIRE® or other suitable data transfer mechanism may be used, and of course any suitable fastener may be used to physically connect the demo dongle 110 to the digital camera 100. In other embodiments, a separate fastener need not be used at all and the connection between port 116 and the corresponding dock on digital camera 100 may be sufficient.

The demo dongle 110 may also include other features. For example, the demo dongle 110 may include a light emitting diode (LED) or other indicator to notify the user when the demo dongle has been properly connected to the digital camera 100 and/or when power is being supplied (or not being supplied) to the digital camera 100 via the demo dongle 110. In another example, demo dongle 110 may include memory and/or a slot for receiving removable memory.

It is noted that the demo dongle 110 is not limited to any particular configuration. In other exemplary embodiments, the demo dongle 110 may be implemented as a cable with port 116. The demo dongle 110 does not need to have the base member 112 or fastener 114. Still other embodiments are also contemplated, as will be readily apparent to those having ordinary skill in the arts after becoming familiar with the teachings herein.

In use, connecting the powered demo dongle 110 to the digital camera 100 automatically enables or activates a demo mode on the digital camera 100. In an exemplary embodiment, the demo mode is embodied in program code (e.g., firmware) resident on the digital camera 100 or in removable memory operatively associated with the digital camera 110. An electrical signal (referred to as the “activation signal”) is issued when the demo dongle 110 is physically connected to the digital camera 100 (e.g., via port 116) and is monitored to activate the demo mode firmware.

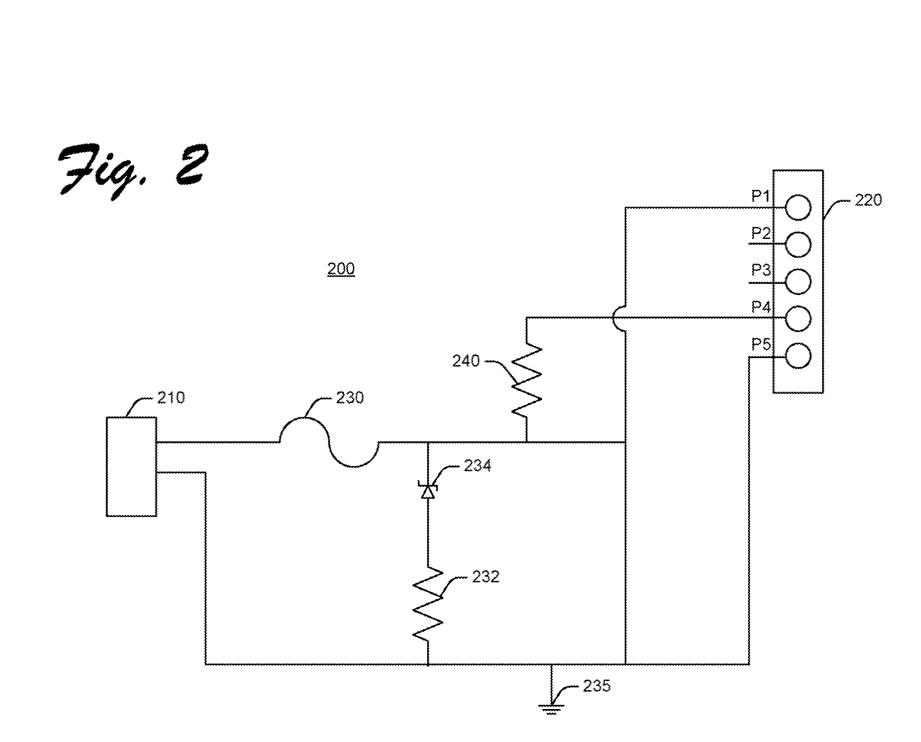

FIG. 2 is a schematic diagram showing an exemplary circuit 200 which may be provided for the demo dongle to implement a demo mode for digital cameras (e.g., demo dongle 110 and digital camera 100 both shown in FIG. 1). Circuit 200 may physically reside in the demo dongle and serves to provide power and the activation signal to activate the firmware for the demo mode on the digital camera.

In an exemplary embodiment, circuit 200 may include a power source 210 and connection 220, such as the USB port 116 shown in FIG. 1. In this embodiment, pin P1 on the connection 220 is connected to the power source 210 to provide power (e.g., positive voltage) to the digital camera, and pin P5 on the connection 220 is connected to ground 235. Fuse 230, resistor 232, and diode 234 provide over-voltage, reverse polarity, and over-current protection for the digital camera.

Also in an exemplary embodiment, pin P4 on the connection 220 is connected to the power source 210. Accordingly, circuit 200 provides a voltage via current limiting resistor 240 to the digital camera via pin P4 when the digital camera is attached to the demo dongle. Firmware for implementing the demo mode is activated when the digital camera detects the demo dongle by detecting the voltage on pin P4.

Optionally, different voltages may indicate which one of a plurality of demo modes the camera should activate. For example, one voltage may indicate a first demo mode wherein advertising is displayed on the digital camera in a retail store, and a different voltage may indicate a second demo mode wherein pictures are displayed on the digital camera upon docking to a printer or print station. Still other demo modes may also be activated (e.g., retailer or region-specific demo modes).

It is noted that the demo dongle is not limited to use with circuit 200. In addition, the circuit 200 may be modified based on a number of design considerations, such as, but not limited to the specific type of electrical connection being implemented for the demo dongle.

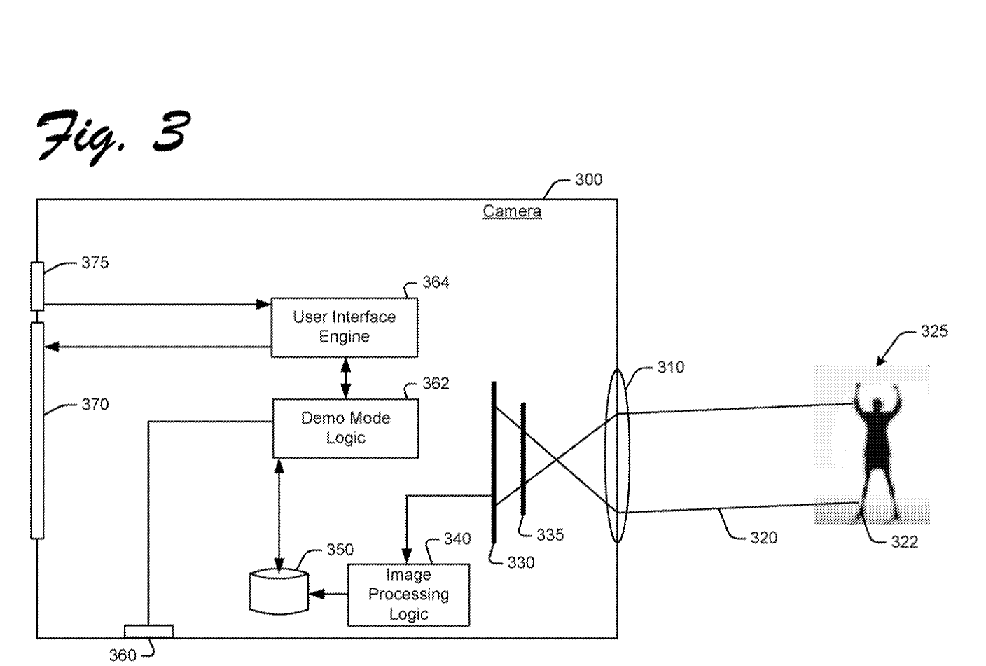

FIG. 3 is a block diagram of exemplary operational components which may be provided for the digital camera shown in FIG. 1 to implement a demo mode. Operational components 300 may include a camera lens 310 positioned to focus light 320 reflected from one or more objects 322 in a scene 325 onto an image capture device or image sensor 330 when a shutter 335 is open (e.g., for image exposure). Operational components 300 may also include image processing logic 340 to convert electrical signals from the image sensor 330 representative of the light 320 captured by the image sensor 330 during exposure to generate a digital image of the scene 325. The digital image may be stored in the camera's memory 350 (e.g., internal memory and/or a removable memory card).

Shutters, image sensors, memory, and image processing logic, such as those illustrated in FIG. 3, are well-understood in the camera and photography arts. These components may be readily provided by those having ordinary skill in the art after becoming familiar with the teachings herein and therefore further description is not necessary.

Operational components 300 may also include input port 360 (e.g., a USB port that mates with port 116 shown in FIG. 1 and the pins on connector 220 in FIG. 2). When the demo dongle is connected to the digital camera, an electrical signal is received via input port 360 to activate demo mode logic 362, as already described above. Optionally, the user may also initiate the demo mode, through the help menu, to demonstrate camera features in a single pass mode or through another key sequence e.g., when the digital camera is docked on a printer for a printer centric demo.

Before continuing, it is noted that although the logic blocks are shown in FIG. 3 for purposes of illustration as being separate, these may all be embodied together in the firmware. It is also noted that the logic blocks may also be embodied in hardware and/or a combination of firmware (or other program code) and hardware.

In an exemplary embodiment, demo mode logic 362 is implemented in program code (e.g., firmware and/or software) residing in memory on the digital camera and executable by a processor in the digital camera, such as the memory and processor typically provided with commercially available digital cameras.

The demo mode logic 362 may be operatively associated with the memory 350 for accessing digital images or “demonstration images” (e.g., advertising or instructional images). In an exemplary embodiment, the demo mode runs continuously when the demo dongle is attached (such as in retail stores), for a selectable timeframe, or cycle count.

The demo mode logic 362 may also be operatively associated with the user interface engine 364. The demonstration images may be displayed on a display 370 as a “slide show” (e.g., the camera's LCD) until the user operates a camera control 375 (e.g., presses a button on the digital camera). After the user operates a camera control 375, displaying the demonstration images may be stopped so that the user can try the various camera features.

The demo mode enables different content for different camera models and updating the slide show by changing the demonstration images without having to update the firmware on the camera. This update may be “permanent,” i.e., remaining on the camera even after the camera is powered off and/or the removable memory containing the update is removed from the camera. For example, a default set of demonstration content (“demo.xml” and associated image files) may be included as part of the master camera firmware image. After starting the demo mode, the firmware may search removable memory (e.g., a secure digital “SD” card inserted into the camera) for files to update the demo mode content within the camera.

In an exemplary embodiment, the demo.xml file defines the details of the demo slide show, image order and display time. The file may specify demonstration images and display time in the format <slide jpg=“filename.img” ms=“xxxx” />. According to this format, “file name” tag identifies the demonstration image file (e.g., a JPEG file), e.g., having up to eight alphanumeric characters and an .img extension. The “ms” tag identifies the number of milliseconds (ms) to display the corresponding demonstration image (e.g., a minimum of 100 ms to a maximum of 65535 ms, or 65.535 seconds). To loop the slideshow, the last line is repeated using a time of “−1”. For purposes of illustration, an exemplary demo.xml file follows:

<show>
<slide jpg=“imageone.img” ms=“2500” />
<slide jpg=“imagetwo.img” ms=“2500” />
<slide jpg=“image3.img” ms=“3000” />
<slide jpg=“image4.img” ms=“3000” />
<slide jpg=“image5.img” ms=“2500” />
<slide jpg=“imagesix.img” ms=“2500” />
<slide jpg=“image7.img” ms=“2500” />
<slide jpg=“image8.img” ms=“2500” />
<slide jpg=“image9.img” ms=“2500” />
<slide jpg=“imageten.img” ms=“2500” />
<slide jpg=“imageten.img” ms=“−1” />
</show>

In the above illustration, the “show” tag indicates the file is appropriate for the demo mode. The “slide” tag is used to described each individual image slide. The xml file may be stored in the camera memory along with the all of the images to be displayed. The file may specify that each demonstration image is to be displayed for a specified amount of time. The demo file and/or demonstration images can be updated using files read from the SD card. The updated files are then stored permanently within the camera flash memory until the next update.

In addition to displaying the slide show specified in the xml file, the demo mode may also include default camera settings. These default camera settings may be optimized for showcasing the camera to potential buyers. For example, the image capture resolution may be reduced so that the user can capture more images on the limited internal memory without having to erase images while trying the camera. In addition, the display brightness may be increased to give the user an idea of what the display is capable of, and so that it appears brighter and more vivid to the potential buyer. Other camera settings may also be set to a default state optimized for the demo mode.

While the user can change settings and experience the camera's features, after a predetermined time of inactivity (or “time-out” period indicating that the user is no longer trying the camera), the demo mode may return the camera settings to a default or predetermined settings so that the next potential buyer can try the camera without having to reset the camera settings made by the previous user.

In addition, the firmware may erase demonstration images, taken by the user, from the camera's internal memory, again so that the next potential buyer to try the camera does not have to do this. In an exemplary embodiment, the slide show images may be designated as protected-class images so that the protected-class images remain on the camera even after deleting the sample images and resetting the camera settings.

Before continuing, it is noted that the embodiments shown and described above are merely exemplary. The systems and methods described herein, however, are not intended to be limited to these embodiments. Other embodiments are also contemplated as will be readily appreciated by those having ordinary skill in the art after becoming familiar with the teachings herein.

Exemplary Operations

Exemplary operations may be embodied as logic instructions on one or more computer-readable medium. When executed on a processor (e.g., in the camera), the logic instructions implement the described operations. In an exemplary embodiment, the components and connections depicted in the figures may be implemented.

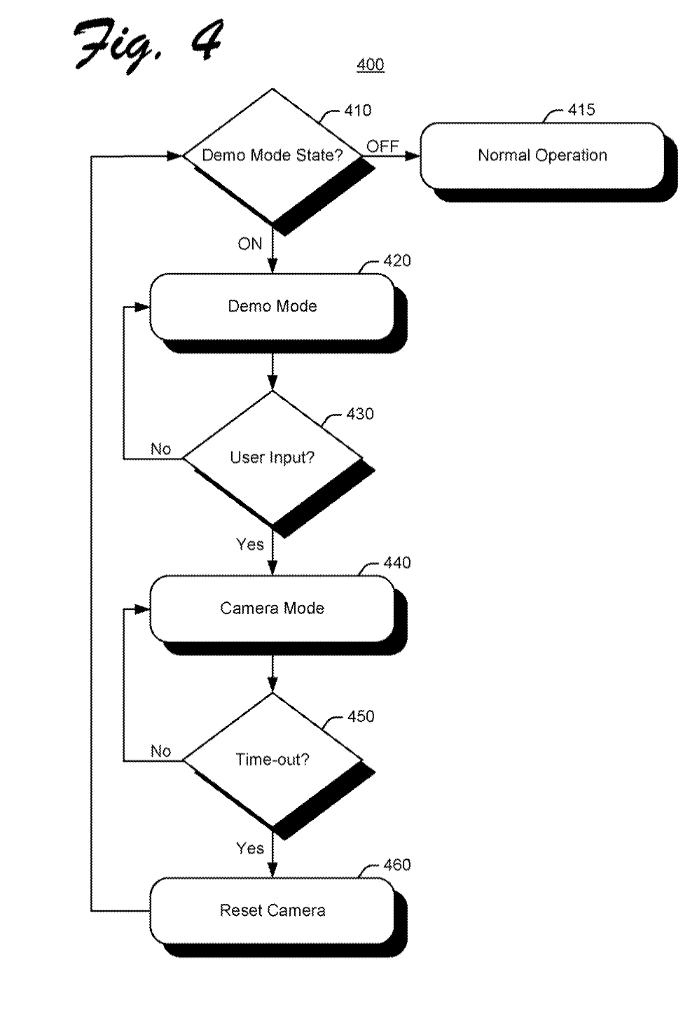

FIG. 4 is a flowchart illustrating exemplary operations 400 to implement a demo mode for digital cameras. In operation 410, the state of a demo mode flag is determined. For example, the demo mode flag may be turned on automatically if the demo dongle is connected to the digital camera. Alternatively, the demo mode flag may be turned on manually by the user. Otherwise, the demo mode flag is off by default. If the demo mode flag is off, the camera continues with normal operation at 415 (i.e., without entering demo mode).

If the demo mode flag is on, the digital camera may enter a demo mode in operation 420. In one example, the firmware searches for a “demo.xml” file on the root of any installed SD card. If found, the demo.xml file is read and each image file specified in the file is located on the root of the card. When all of the files are located, the demo.xml file and image files may be copied to the program flash (NAND), overwriting the existing demo files in the camera's memory. After the search and read/copy for updated demo files, the demo function then executes by reading the demo.xml file in NAND.

During execution of the demo mode, the firmware may monitor the digital camera for user input in operation 430. The demo mode continues in operation 420 until user input is detected, and the camera enters a camera mode in operation 440. During camera mode, the demo mode is suspended (e.g., stopped or paused) so that the user can try various features of the digital camera, e.g., by changing camera settings and/or taking sample images.

In operation 450, a determination is made whether the digital camera is still being used or if it should be returned to the demo mode. When the digital camera is inactive for a predetermined time, thereby indicating the user is no longer trying the digital camera, the camera settings are reset in operation 460.

It is noted that the exemplary operations described with reference to FIG. 4 are merely exemplary and are not limiting. For example, the operations are not limited to the ordering shown in FIG. 4. Additional, fewer and/or different operations may also be implemented. For example, if the camera is in demo mode and the power button is pressed, the camera may be powered off. If the user turns the camera back on before the time-out in operation 450, the camera may “wake up” and ignore the time-out. Accordingly, the user is able to try even the power button on the camera without the camera returning to the slide show.

It is also noted that the exemplary embodiments shown and described are provided for purposes of illustration and are not intended to be limiting. Still other embodiments to implement a demo mode for digital cameras are also contemplated.

1. A method of demonstrating a digital camera to a user comprising:
activating a demo mode that displays demonstrative camera display images;
suspending the demo mode so that a user can try various camera settings; and
after a time-out, resetting the camera settings to a default state.

2. The method of claim 1 wherein the user can take at least one sample picture which is stored on the camera for the user while the demo mode is suspended, and wherein any sample pictures are deleted after the time-out.

3. The method of claim 1 further comprising displaying at least one protected-class picture with the demonstrative camera display images, the at least one protected-class picture remaining on the camera even after deleting any sample pictures and resetting the camera settings.

4. The method of claim 3 further comprising updating the at least one protected-class picture with at least one new image from a memory card.

5. The method of claim 1 wherein the demo mode is resident on the camera and activated manually by a user from a menu option on the camera.

6. The method of claim 1 wherein the demo mode is resident on the camera and activated without user input when a demo mode dongle is connected to the camera.

7. The method of claim 6 wherein the demo mode is activated by an electrical signal received at a predetermined port on the camera indicating that the demo dongle is connected to the camera.

8. The method of claim 1 wherein a second demo mode is activated by an electrical signal received at a predetermined port on the camera indicating that the camera is docked to a printer.

9. An electronic device comprising:
a port configured to receive an external electrical signal; and
program code stored in memory, the program code executing at least one demo mode on the electronic device in response to receiving the external electrical signal.

10. The electronic device of claim 9 wherein the demo mode is automatically suspended when a user tries various device settings and optionally takes at least one sample picture which is temporarily stored in the memory for the user.

11. The electronic device of claim 10 wherein the demo mode deletes the at least one sample picture from the memory after a time-out.

12. The electronic device of claim 9 wherein the demo mode resets the device settings to a default state after a time-out.

13. The electronic device of claim 9 wherein a voltage level of the electrical signal indicates which of a plurality of demo modes to activate.

14. The electronic device of claim 13 wherein a second demo mode is activated if docked to another device.

15. The digital camera of claim 9 further comprising at least one protected-class picture with demonstrative camera display images, the at least one protected-class picture is retained in the memory.

16. The electronic device of claim 9 further comprising a menu option for manually activating the demo mode.

17. The electronic device of claim 16 wherein manually activating the demo mode is with a button sequence.

18. The electronic device of claim 16 wherein manually activating the demo mode is with a button sequence pressed and held for a predetermined duration.

19. The electronic device of claim 9 wherein the external electrical signal is received from a demo dongle.

20. A system comprising:
means for receiving an activation signal on an imaging device;
means for activating at least one demo mode on the imaging device in response to receiving the activation signal; and
means for suspending the at least one demo mode so that a user can try various features of the imaging device.

21. The system of claim 20 further comprising means for resetting device settings to a default state and then re-entering the at least one demo mode after a time-out.

22. The system of claim 20 further comprising means for selectively erasing images captured by the user that are not in a protected class.

23. The system of claim 20 wherein the activation signals includes button-press means.
